(19) United States
(12) Patent Application Publication
(10) Pub. No.: US 2012/0032870 A1
(43) Pub. Date: Feb. 9, 2012

(54) BROADBAND ANTENNA USING COUPLING MATCHING WITH SHORT-CIRCUITED END OF RADIATOR

(75) Inventors: Byong-Nam Kim, Kyeonggi-Do (KR); Jong-Ho Jung, Gyeonggi-Do (KR)

(73) Assignee: ACE TECHNOLOGIES CORPORATION, Incheon (KR)

(21) Appl. No.: 13/264,680

(22) PCT Filed: Apr. 14, 2009
(86) PCT No.: PCT/KR2009/001925

§ 371 Date: Oct. 19, 2011

(30) Foreign Application Priority Data
Apr. 14, 2009 (KR) 10-2009-0032386

(51) Int. Cl. H01Q 9/04; H01Q 1/50

(52) U.S. Cl. 343/860; 343/700 MS

(57) ABSTRACT

An antenna, where an end point of a radiator is shorted, using coupling matching is disclosed. The antenna includes a first conductive element connected electrically to a first ground, a second conductive element connected electrically to a feeding part, and spaced from the first conductive element by a certain distance, a third conductive element extending from the first conductive element and configured to output a RF signal, an end point of the third conductive element being coupled to a second ground. Here, the first conductive element and the second conductive element have a certain length so that a travelling wave is generated and enough coupling is provided. The antenna provides wide band characteristics while maintaining a low profile structure. The frequency characteristics of the antenna are not changed significantly due to external factors such as hand effect and head effect.

### TECHNICAL FIELD

Example embodiment of the present invention relates to an antenna, more particularly relates to an antenna for implementing impedance matching for wide band.

### BACKGROUND ART

In current mobile terminals, there is a demand for functions that allow a user access to mobile communication services of different frequency bands through a single terminal. That is, there is a demand for a terminal with which a user may simultaneously utilize signals of multiple bands as necessary, from among mobile communication services of various frequency bands, such as the CDMA service based on the 824˜894 MHz band and the PCS service based on the 1750˜1870 MHz band commercialized in Korea, the CDMA service based on the 832˜925 MHz band commercialized in Japan, the PCS service based on the 1850˜1990 MHz commercialized in the United States, the GSM service based on the 880˜960 MHz band commercialized in Europe and China, and the DCS service based on the 1710˜1880 MHz band commercialized in parts of Europe.

Furthermore, there is a demand for a composite terminal that allows the use of services such as Bluetooth, ZigBee, wireless LAN, GPS, etc. In this type of terminal for using services of multiple bands, a multi-band antenna is needed, which can operate in two or more desired bands. The antennas generally used in mobile terminals include the helical antenna and the planar inverted-F antenna (PIFA).

The helical antenna is an external antenna that is secured to an upper end of a terminal, and is used together with a monopole antenna. In an arrangement in which a helical antenna and a monopole antenna are used together, extending the antenna from the main body of the terminal allows the antenna to operate as a monopole antenna, while retracting the antenna allows the antenna to operate as a λ/4 helical antenna. While this type of antenna has the advantage of high gain, its non-directivity results in undesirable SAR characteristics, which form the criteria for levels of electromagnetic radiation hazardous to the human body. In addition, since the helical antenna is formed protruding outwards of the terminal, it is difficult to design the exterior of the terminal to be aesthetically pleasing and suitable for carrying.

The inverted-F antenna is an antenna designed to have a low profile structure in order to overcome such drawbacks. The inverted-F antenna has directivity, and when current induction to the radiating part generates beams, a beam flux directed toward the ground surface may be re-induced to attenuate another beam flux directed toward the human body, thereby improving SAR characteristics as well as enhancing beam intensity induced to the radiating part. Also, the inverted-F antenna operates as a rectangular micro-strip antenna, in which the length of a rectangular plate-shaped radiating part is reduced in half, whereby a low profile structure may be realized.

Since the inverted-F antenna has the directive radiation characteristics, the inverted-F antenna may have excellent electromagnetic radiation absorption rate compared to the helical antenna. However, the inverted-F antenna may have a narrow frequency bandwidth, and thus it is difficult to design an antenna operating in multiple bands.

In addition, the frequency characteristics of the inverted-F antenna may be easily changed due to external factors such as hand effect or head effect.

### DISCLOSURE

### Technical Problem

To resolve the problems in prior art described above, an objective of the present invention provides an antenna for implementing wide band characteristics with maintaining low profile characteristics.

Another objective of the present invention provides an antenna for implementing wide band characteristics through coupling matching.

Still another objective of the present invention provides an antenna of which frequency characteristics is less changed by external factors such as hand effect and head effect.

### Technical Solution

To achieve the objectives above, an aspect of the present provides a wide-band antenna using a coupling method comprising: a first conductive element connected electrically to a first ground; a second conductive element connected electrically to a feeding part, and spaced from the first conductive element by a certain distance; and a third conductive element extending from the first conductive element and configured to output a RF signal, an end point of the third conductive element being coupled to a second ground, wherein the first conductive element and the second conductive element have a certain length to generate a travelling wave and implement adequate coupling.

The first conductive element and the second conductive element operate as an impedance matching/feeding part, and impedance matching between the first conductive element and the second conductive element is performed through coupling generated in the impedance matching/feeding part.

The first ground is identical to the second ground.

A radiation frequency is determined by a length of the first conductive element and a length of the third conductive element, and the electrical length of the first conductive element and the electrical length of the third conductive element are set 0.5 times the wavelength.

The wide-band antenna further comprises a fourth conductive element coupled to a third ground and spaced from the first conductive element by a certain distance, and configured to operate as another radiator.

Another aspect of the present invention provides a wide-band antenna using a coupling method comprising: a first conductive element connected electrically to a ground; a second conductive element connected electrically to a feeding part, and spaced from the first conductive element by a certain distance; and a third conductive element extending from the first conductive element and configured to output a RF signal, an end point of the third conductive element being coupled to the ground, wherein, a plurality of open stubs protrude from the first conductive element and the second conductive element, the plurality of open stubs protruding between the first conductive element and the second conductive element.

The open stubs protruding from the first conductive element and the second conductive element mesh with one another.

The open stubs have a uniform width and length.

The open stubs have partially varying widths and lengths.

The wide-band antenna further comprises a fourth conductive element coupled to the ground, the fourth conductive element being spaced from the first conductive element by a certain distance, and configured to operate as a radiator for another band.

### Advantageous Effects

Certain aspects of the present invention can provide antennas for implementing wide band characteristics with maintaining a low profile structure, and its frequency characteristics may be less changed by external factors such as hand effect and head effect.

### DESCRIPTION OF DRAWINGS

Example embodiments of the present invention will become more apparent by describing in detail example embodiments of the present invention with reference to the accompanying drawings, in which:

FIG. 1 illustrates a conceptual structure of a wide-band internal antenna, in which an end point of a radiator is shorted, using a coupling method according to the first example embodiment of the present invention;

FIG. 2 illustrates a wide-band internal antenna, in which an end point of a radiator is shorted, using a coupling method according to a first example embodiment of the present invention;

FIG. 3 illustrates a conceptual structure of a wide-band internal antenna, in which an end point of a radiator is shorted, using a coupling method according to a second example embodiment of the present invention;

FIG. 4 illustrates a wide-band internal antenna, in which an end point of a radiator is shorted, using a coupling method according to the second example embodiment of the present invention;

FIG. 5 illustrates a conceptual structure of a wide-band internal antenna, in which an end point of a radiator is shorted, using a coupling method according to a third example embodiment of the present invention;

FIG. 6 illustrates a wide-band internal antenna, in which an end point of a radiator is shorted, using a coupling method according to the third example embodiment of the present invention;

FIG. 7 illustrates a wide-band internal antenna, in which an end point of a radiator is shorted, using a coupling method according to a fourth example embodiment of the present invention; and

FIG. 8 illustrates S11 parameter of the antenna according to the fourth embodiment of the present invention.

### MODE FOR INVENTION

Hereinafter, wide-band antennas using a coupling method according to embodiments of the present invention will be described in detail with reference to accompanying drawings.

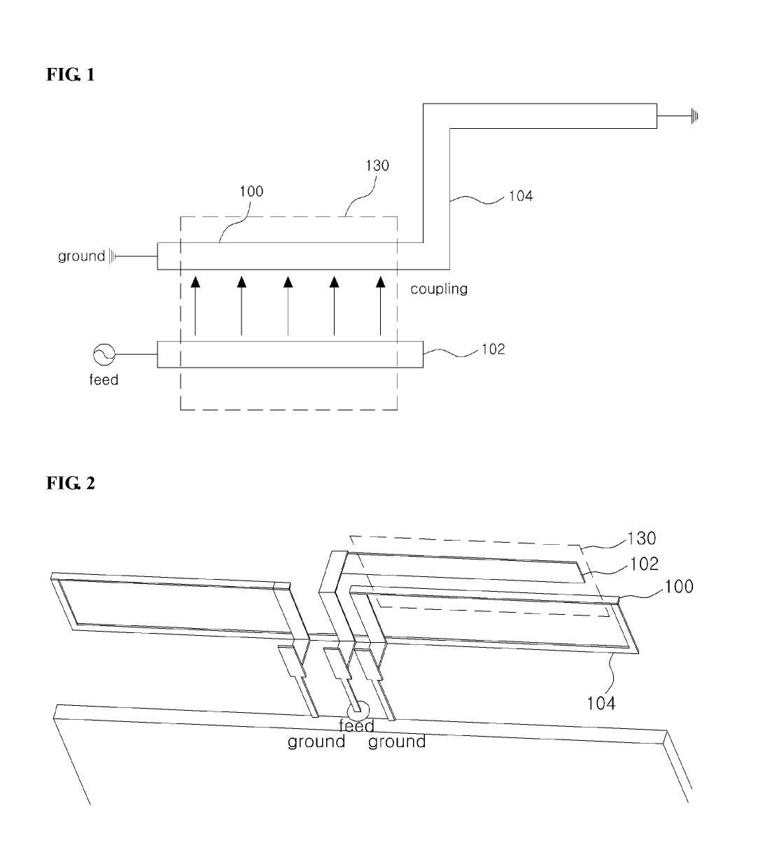

FIG. 1 illustrates a conceptual structure of a wide-band internal antenna, in which an end point of a radiator is shorted, using a coupling method according to the first example embodiment of the present invention. FIG. 2 illustrates a wide-band internal antenna, in which an end point of a radiator is shorted, using a coupling method according to a first example embodiment of the present invention.

In FIG. 1, the wide-band antenna of the present embodiment may include a first conductive element 100 connected electrically to a ground, a second conductive element 102 connected electrically to a feeding part and a third conductive element 104 extending from the first conductive element 100.

The first conductive element 100 coupled to the ground and the second conductive element 102 coupled to the feeding part are formed with a particular gap in-between. It is desirable that the first conductive element 100 and the second conductive element 102 are arrayed in parallel, but this array is not necessary. The first conductive element 100 and the second conductive element 102 operate as an impedance matching/feeding part 130.

The impedance matching/feeding part 130 performs impedance matching and coupling feeding. A traveling wave is generated between the first conductive element 100 and the second conductive element 102 in the impedance matching/feeding part 130, and a certain power is fed to the first conductive element 100 from the second conductive element 102 through coupling.

If the impedance matching for wide band is implemented in the impedance matching/feeding part 130, enough coupling should be performed between the first conductive element 100 and the second conductive element 102. In order for enough coupling, the first conductive element 100 and the second conductive element 102 must assure a given length. When the conductive elements 100 and 102 have the greater length, the wider band may be realized.

The third conductive element 104 extends from the first conductive element 100 related to the coupling matching, and operates as a radiator. As shown in FIG. 1 and FIG. 2, an end point of the third conductive element 104 operating as the radiator is connected electrically to the ground, and so the third conductive element 104 operates as a loop radiator. Since a radiation frequency of the antenna is determined by the lengths of the conductive elements 100 and 104 and the third conductive element 104 operates as the loop radiator, the lengths of the conductive elements 100 and 104 may have approximately 0.5 times the wavelength (λ) corresponding to frequency used.

As shown in FIG. 1 and FIG. 2, in case that the coupling matching and the coupling feeding are performed with utilizing the loop radiator of which the end point is shorted, the antenna may be excellent in view of hand effect and head effect, and obtain the wide band characteristics.

In FIG. 2, the first conductive element 100 is connected electrically to the ground formed on a substrate 200, and the second conductive element 102 is connected electrically to a feeding line. It is desirable that the ground, to which the end point of the third conductive element 104 is coupled, is identical to the ground to which the first conductive element 100 is coupled.

On the other hand, the first conductive element 100, the second conductive element 102 and the third conductive element 104 included in the antenna in FIG. 2 may be combined on a carrier of the antenna.

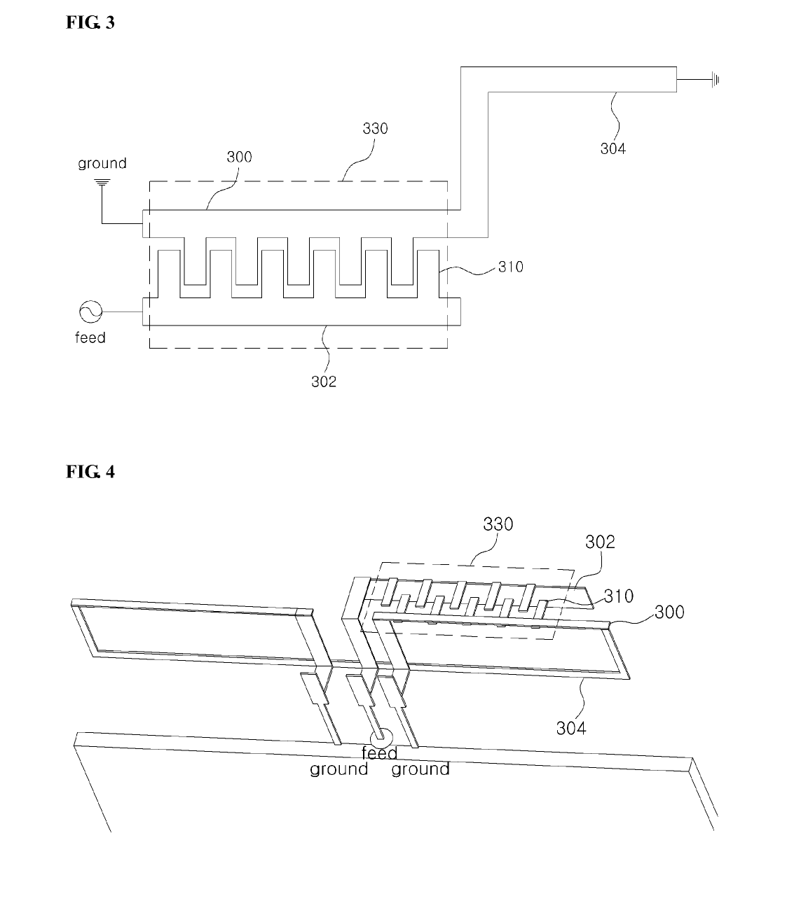

FIG. 3 illustrates a conceptual structure of a wide-band internal antenna, in which an end point of a radiator is shorted, using a coupling method according to a second example embodiment of the present invention. FIG. 4 illustrates a wide-band internal antenna, in which an end point of a radiator is shorted, using a coupling method according to the second example embodiment of the present invention.

In FIG. 3 and FIG. 4, the antenna of the present embodiment may include a first conductive element 300 connected electrically to a ground, a second conductive element 302 connected electrically to a feeding part, a third conductive element 304 extended from the first conductive element 300, and plural open stubs 310 protruded from the first conductive element 300 and the second conductive element 302. Here, an end point of the third conductive element 304 is shorted.

In the antenna of the second embodiment shown in FIG. 3 and FIG. 4 unlike in the first embodiment, the open stubs 310 protrude from the conductive elements 300 and 302, operating as an impedance matching/feeding part 330, between the conductive elements 300 and 302. FIG. 3 and FIG. 4 show the open stubs 310 having a rectangular shape, but it will be immediately obvious to those skilled in the art that the open stubs 310 have another shape.

As described above, the wider band may be obtained when the conductive elements 300 and 302 have the greater length. This means that the impedance matching for the wider band may be obtained by increasing capacitance component between the first conductive element 300 and the second conductive element 302. Accordingly, the impedance matching for the wide band may be obtained when the distance between the first conductive element 300 and the second conductive element 302 is short.

The open stubs 310 protruding from the first conductive element 300 and the second conductive element 302 in FIG. 3 and FIG. 4 substantially increase electrical lengths of the first conductive element 300 and the second conductive element 302, and thus the impedance matching for the wide band may be performed though the conductive elements 300 and 302 have limited lengths. When the open stubs 410 protrude from the first conductive element 400 and second conductive element 402 in this manner to mesh with one another, the distance between the first conductive element 400 and the second conductive element 402 may be reduced, so that a greater capacitance value may be obtained during the coupling matching, and the impedance matching may be obtained for a wider band.

That is, the structure having plurality of open stubs protruding from the first conductive element and second conductive element and meshing with one another can not only substantially increase the electrical length of the first conductive element and second conductive element, but also reduce the distance between the first conductive element and second conductive element, so that a longer electrical length and a larger capacitance component may be obtained, which allow impedance matching for wider band even with a limited size.

The third conductive element 304 extending from the first conductive element 300 related to the coupling matching, and operates as a radiator. As shown in FIG. 3 and FIG. 4, an end point of the third conductive element 304 operating as the radiator is connected electrically to the ground, and so the third conductive element 304 operates as a loop radiator. Since a radiation frequency of the antenna is determined by the electrical lengths of the conductive elements 300 and 304 and the third conductive element 304 operates as the loop radiator, the lengths of the conductive elements 300 and 304 may have approximately 0.5 times the wavelength (λ) corresponding to an use frequency.

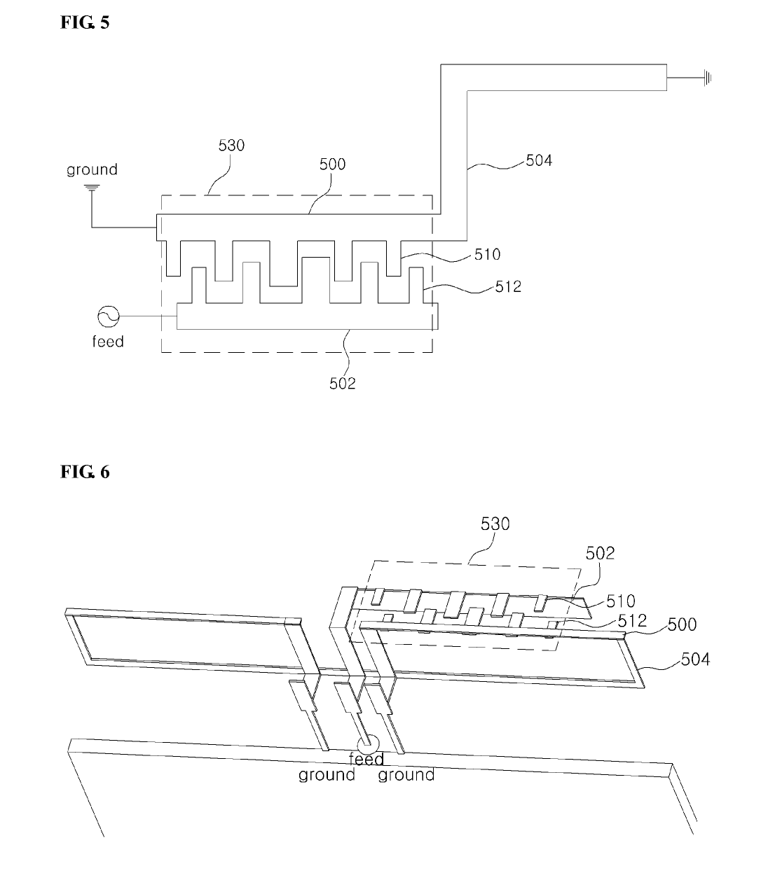

FIG. 5 illustrates a conceptual structure of a wide-band internal antenna, in which an end point of a radiator is shorted, using a coupling method according to a third example embodiment of the present invention. FIG. 6 illustrates a wide-band internal antenna, in which an end point of a radiator is shorted, using a coupling method according to the third example embodiment of the present invention.

In FIG. 5 and FIG. 6, an antenna of the present embodiment may include a first conductive element 500 connected electrically to a ground, a second conductive element 502 connected electrically to a feeding part, a third conductive element 504 extending from the first conductive element 500, first open stubs 510 protruding from the first conductive element 500 and second open stubs 512 protruding from the second conductive element 502.

Shapes of the open stubs 510 and 512 protruding from the conductive elements 500 and 502 in the third embodiment shown in FIG. 5 and FIG. 6 are different from those in the second embodiment. In the second embodiment, the open stubs 301 protruding from the conductive elements 300 and 302 have the same widths and lengths. In other words, the open stubs 310 in the second embodiment are formed uniformly, but the open stubs 510 and 512 in the third embodiment are not formed uniformly.

In FIG. 5 and FIG. 6, the first open stubs 510 protruding from the first conductive element 500 may be structured to increase in width and length and then decrease again, and the second open stubs 612 that protrude from the second conductive element 602 may be structured to increase in width and length and then decrease again, also.

Capacitance component for the coupling is diversified by varying the widths and the lengths of the open stubs 510 and 512 protruding from the conductive elements 500 and 502. In case that the capacitance component between the first conductive element 500 and the second conductive element 502 is diversified, the impedance matching for wider band may be obtained.

The structure of the open stubs 510 and 512 shown in FIG. 5 and FIG. 6 is one example, and it will be obvious to those skilled in the art that the widths and the lengths of the open stubs 510 and 512 may be variously modified. For example, only the width of the first open stubs may be varied without varying length of the first open stubs. Otherwise, the width or the length may be varied for only one of the first open stub and the second open stub.

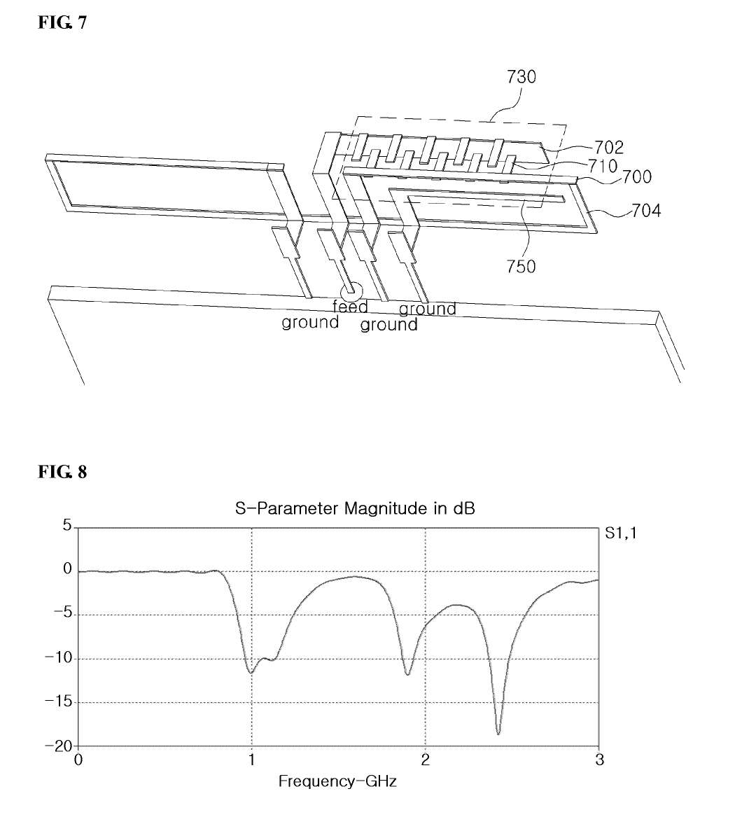

FIG. 7 illustrates a wide-band internal antenna, in which an end point of a radiator is shorted, using a coupling method according to a fourth example embodiment of the present invention.

In FIG. 7, the antenna of the present embodiment may include a first conductive element 700 connected electrically to a ground, a second conductive element 702 connected electrically to a feeding part, a third conductive element 704 extending from the first conductive element 700, open stubs 710 protruding from the first conductive element 700 and the second conductive element 702, and a fourth conductive element 750 spaced from the first conductive element 700 by a certain distance and connected electrically to the ground.

The antenna of the fourth embodiment further includes the fourth conductive element 750 compared with the second embodiment, the fourth conductive element 750 operating as a second radiator. In FIG. 7, the fourth conductive element 750 is adjacent to the first conductive element 700, and a certain power is fed to the fourth conductive element 750 from the first conductive element 700 through a coupling method. On the other hand it will be immediately obvious to those skilled in the art that the fourth conductive element 720 may be adjacent to the second conductive element 702, and a certain power may be fed to the fourth conductive element 720 from the second conductive element 702 through the coupling method, thereby outputting a RF signal.

The fourth conductive element 750 operating as the second radiator radiates the RF signal in higher frequency band than the third conductive element 704 operating as a first radiator.

FIG. 8 is a view illustrating S11 parameter of the antenna according to the fourth embodiment of the present invention.

As shown in FIG. 8, in a low frequency band, a resonance band is formed by the third conductive element of which the end point is coupled to the ground. Here, the antenna has wide band characteristics due to the coupling between the first conductive element and the second conductive element. In a high frequency band of approximately 2 GHz, multiple resonance in accordance with the third conductive element and a resonance in accordance with the fourth conductive element are combined, i.e. dual resonance is generated, and so the wide band characteristics may be obtained.

1. A wide-band antenna using a coupling method comprising:
a first conductive element connected electrically to a first ground;
a second conductive element connected electrically to a feeding part, and spaced from the first conductive element by a certain distance; and
a third conductive element extending from the first conductive element and configured to output a RF signal, an end point of the third conductive element being coupled to a second ground,
wherein the first conductive element and the second conductive element have a certain length to generate a travelling wave and implement adequate coupling.

2. The wide-band antenna according to claim 1, wherein the first conductive element and the second conductive element operate as an impedance matching/feeding part, and impedance matching between the first conductive element and the second conductive element is performed through coupling generated in the impedance matching/feeding part.

3. The wide-band antenna according to claim 2, wherein the first ground is identical to the second ground.

4. The wide-band antenna according to claim 1, wherein a radiation frequency is determined by a length of the first conductive element and a length of the third conductive element, and the electrical length of the first conductive element and the electrical length of the third conductive element are set 0.5 times a wavelength.

5. The wide-band antenna according to claim 1, further comprising:
a fourth conductive element coupled to a third ground and spaced from the first conductive element by a certain distance, and configured to operate as another radiator.

6. A wide-band antenna using a coupling method comprising:
a first conductive element connected electrically to a first ground;
a second conductive element connected electrically to a feeding part, and spaced from the first conductive element by a certain distance; and
a third conductive element extending from the first conductive element and configured to output a RF signal, an end point of the third conductive element being coupled to a second ground,
wherein, a plurality of open stubs protrude from the first conductive element and the second conductive element, the plurality of open stubs protruding between the first conductive element and the second conductive element.

7. The wide-band antenna according to claim 6, wherein the open stubs protruding from the first conductive element and the second conductive element mesh with one another.

8. The wide-band antenna according to claim 7, wherein the open stubs have a uniform width and length.

9. The wide-band antenna according to claim 7, wherein the open stubs have partially varying widths and lengths.

10. The wide-band antenna according to claim 6, further comprising:
a fourth conductive element coupled to the ground, the fourth conductive element being spaced from the first conductive element by a certain distance, and configured to operate as a radiator for another band.
